(19) United States
(12) Patent Application Publication
(10) Pub. No.: US 2006/0098104 A1
(43) Pub. Date: May 11, 2006

(54) Image capturing apparatus

(75) Inventors: Tomoji Fujii, Osaka (JP); Michiko Kaihotsu, Osaka (JP); Osamu Tanaka, Hashimoto-shi (JP); Koji Yasuda, Osaka (JP); Yoshito Konishi, Osaka (JP)

Correspondence Address: BRINKS HOFER GILSON & LIONE, P.O. BOX 10395, CHICAGO, IL, 60610, US

(73) Assignee: KONICA MINOLTA PHOTO IMAGING, INC.

(21) Appl. No.: 11/080,840

(22) Filed: Mar. 14, 2005

(30) Foreign Application Priority Data
Nov. 11, 2004 (JP) JP2004-327589

(51) Int. Cl. H04N 5/228

(52) U.S. Cl. 348/222.1

(57) ABSTRACT

The present invention provides an image capturing apparatus capable of easily finding an unsatisfactory point peculiar to a group picture at the time of taking a group picture and capable of taking a group picture with which all of subjects to be photographed are satisfied. An image capturing apparatus according to the present invention includes an image capturing part, an operation part for operating the image capturing part, a display part for displaying a picture captured by the image capturing part, an image-capturing control part for performing a control so that the image capturing part performs pre-picture capturing in accordance with an operation of the operation part, an evaluation part for carrying out a predetermined analysis on a pre-picture captured by the pre-picture capturing and determining the presence/absence of an unsatisfactory point peculiar to a group picture, and a notification part, when the evaluation part determines that the pre-picture has the unsatisfactory point, for notifying the user of the unsatisfactory point.

This application is based on application No. 2004-327589 filed in Japan, the contents of which are hereby incorporated by reference.

### BACKGROUND OF THE INVENTION

1. Field of the Invention

The present invention relates to an image capturing apparatus and, more particularly, to an image capturing apparatus capable of capturing an optimum group picture.

2. Description of the Background Art

In sightseeing resorts and the like, a number of people often gather to take a group picture. A group picture has, however, a problem of an unsatisfactory point such that due to short distances between neighboring persons, the face of a person is partially obstructed by the neighboring person. There is also a problem such that, since the number of people to be photographed is large, the photographer cannot check unsatisfactory points such as closing eyes, looking aside, and movement of the faces of all of the people to be photographed at the time of taking a picture. In order to avoid the unsatisfactory points peculiar to a group picture as much as possible, in the case of a camera using a silver halide film, photographing is performed a plurality of times and the best picture is selected from the pictures taken.

Also in the case of using a digital camera, in order to avoid unsatisfactory points peculiar to a group picture as much as possible, photographing is performed a plurality of times. Japanese Patent Application Laid-Open No. 2001-45355 discloses an invention in which when the shutter release button of a camera is depressed, a control part performs continuous image capturing, each of persons photographed selects a preferred picture from a plurality of taken pictures, and the selected pictures are synthesized to one group picture.

In the case of a camera using a silver halide film, a taken picture can be checked only after development and all of taken pictures may have unsatisfactory points. Consequently, there is a problem that the unsatisfactory points peculiar to a group picture cannot be always eliminated. In the case of a digital camera, a taken picture can be checked immediately. However, the work of finding an unsatisfactory point from the picture, correcting the standing position of a person, and taking a picture again has to be repeated. Since a group picture taken in a sightseeing resort or the like has to be taken within limited time, there is also a limitation in avoiding the unsatisfactory points. Such a case has a problem that the psychological burden on the user is heavy since the user has to find unsatisfactory points in short time.

Further, in the case of Japanese Patent Application Laid-Open No. 2001-45355, a process of synthesizing a plurality of pictures is necessary in addition to photographing, so that it is difficult to carry out this invention easily. If all of pictures taken by continuous image capturing have unsatisfactory points, the unsatisfactory points cannot be eliminated even by using the method of Japanese Patent Application Laid-Open No. 2001-45355.

As the number of people to be photographed in a group picture increases, the probability of occurrence of an unsatisfactory point of overlap of faces becomes higher. Closing eyes, looking aside, and movement of the face among the unsatisfactory points peculiar to a group picture can be prevented to a certain extent when the photographer calls attention. It is difficult to prevent obstruction of a face since the person to be photographed himself/herself does not notice it unless his/her eyes are obstructed.

### SUMMARY OF THE INVENTION

It is an object of the present invention to provide an image capturing apparatus capable of easily finding an unsatisfactory point peculiar to a group picture at the time of taking a group picture, and capable of taking a group picture with which all of subjects to be photographed are satisfied.

An image capturing apparatus of the present invention includes an image capturing part, an operation part, a display part, an image-capturing control part, an evaluation part and a notification part. The operation part operates the image capturing part. The display part displays a picture captured by the image capturing part. The image-capturing control part performs a control so that the image capturing part performs pre-picture capturing in accordance with an operation of the operation part. The evaluation part carries out a predetermined analysis on a pre-picture captured by the pre-picture capturing, and determines the presence/absence of an unsatisfactory point peculiar to a group picture. When the evaluation part determines that the pre-picture has the unsatisfactory point, the notification part notifies the user of the unsatisfactory point.

The image capturing apparatus according to the present invention has effects of easily finding an unsatisfactory point peculiar to a group picture at the time of taking a group picture, and taking a group picture with which all of subjects to be photographed are satisfied. The image capturing apparatus according to the present invention can lessen the psychological burden on the user at the time of capturing a group picture.

An image capturing apparatus according to the present invention can select, as a setting mode, a group picture mode of capturing an image of a plurality of subjects gathered and includes, as a group of parts activated in the group picture mode, a live view part, an evaluation part and a notification part. The live view part repeatedly performs image capturing in an image capturing part. The evaluation part carries out a predetermined analysis on a picture captured by the live view part, and determines the presence/absence of an unsatisfactory point peculiar to a group picture. When the evaluation part determines that the picture has the unsatisfactory point, the notification part notifies the user of the unsatisfactory point by superimposing indication of the presence of the unsatisfactory point on the picture.

The image capturing apparatus according to the present invention has effects of easily finding an unsatisfactory point peculiar to a group picture at the time of taking a group picture, and taking a group picture with which all of subjects to be photographed are satisfied.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a front external view of an image capturing apparatus according to a first preferred embodiment of the present invention;

FIG. 2 is a rear external view of the image capturing apparatus according to the first preferred embodiment of the present invention;

FIG. 3 is a block diagram of the image capturing apparatus according to the first preferred embodiment of the present invention;

FIG. 4 is a diagram showing a display of the image capturing apparatus according to the first preferred embodiment of the present invention;

FIG. 5 is a diagram showing a display of the image capturing apparatus according to the first preferred embodiment of the present invention;

FIG. 6 is a flowchart showing operations of the image capturing apparatus according to the first preferred embodiment of the present invention;

FIGS. 7A to 7F are diagrams showing displays including an unsatisfactory point of obstruction of a face in the image capturing apparatus according to the first preferred embodiment of the present invention;

FIGS. 8A to 8F are diagrams showing displays including an unsatisfactory point of looking aside in the image capturing apparatus according to the first preferred embodiment of the present invention;

FIG. 9 is a flowchart showing operations of an image capturing apparatus according to a second preferred embodiment of the present invention; and

FIG. 10 is a flowchart showing operations of an image capturing apparatus according to a third preferred embodiment of the present invention.

### DESCRIPTION OF THE PREFERRED EMBODIMENTS

### First Preferred Embodiment

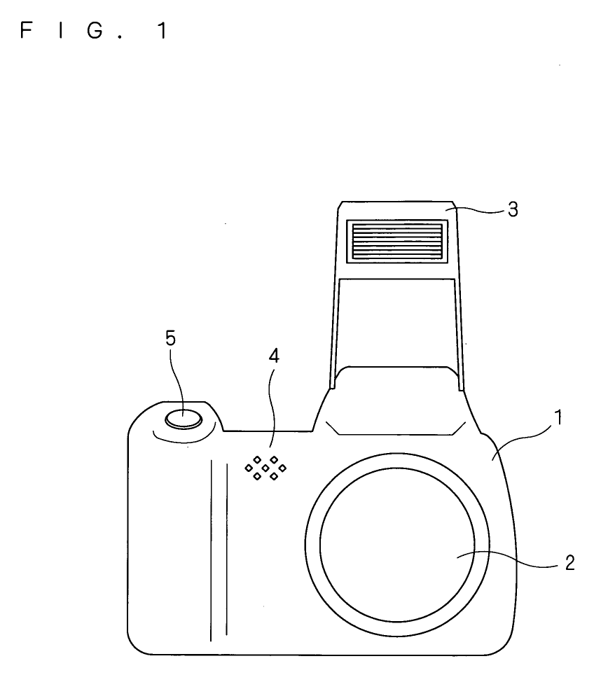

FIG. 1 is a front external view of an image capturing apparatus according to a first preferred embodiment. FIG. 2 is a rear external view of the image capturing apparatus according to the first preferred embodiment. An image capturing apparatus 1 shown in FIG. 1 is constructed as a digital camera and has a taking lens 2. The image capturing apparatus 1 has an electronic-flash 3, a microphone 4 and a release button 5.

The release button 5 is a two-level switch capable of detecting a half-pressed state and a fully depressed state. When the release button 5 is half-pressed in a still picture capturing mode, the taking lens 2 is moved to a focus position by AF (autofocus), and AE (autoexposure) is performed. On the other hand, when the release button 5 is fully depressed in the still picture capturing mode, an image capturing operation, to be specific, an image capturing operation for recording is performed.

In FIG. 2, a mode setting dial 6 is provided on the top face of the image capturing apparatus 1. The mode setting dial 6 is a dial for switching and setting a still picture capturing mode for capturing an image of a subject and recording a still picture, a group picture mode for capturing an image of a group of subjects gathered, a motion picture mode for capturing a motion picture, a playback mode for reproducing pictures recorded on a memory card, and the like.

On the rear face of the image capturing apparatus 1, an LCD (Liquid Crystal Display) monitor 7 for displaying a captured image and the like, an electronic viewfinder (EVF) 8, a zoom button (four-way switch) 9, an automatic trimming button 10, and various setting buttons 11 are provided.

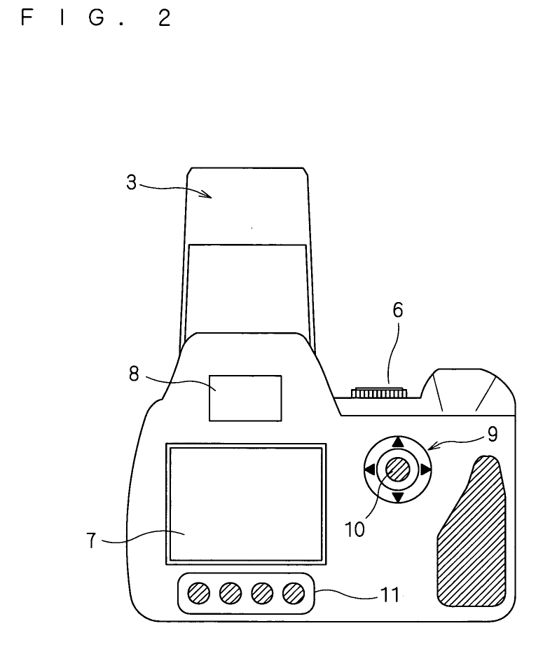

FIG. 3 is a diagram showing functional blocks of the image capturing apparatus 1. The image capturing apparatus 1 has a CCD 21 as a component of an image capturing part, a timing control circuit 22 for supplying a timing signal to the CCD 21, and a signal/image processing part 23 to which image data is supplied from the CCD 21 and the timing signal is supplied from the timing control circuit 22.

The image capturing apparatus 1 has a control part 24 which performs various controls in accordance with an operation on the release button 5, mode setting dial 6, various setting buttons 11, and the like in an operation part 25. For example, the control part 24 controls a lens drive part 26 to drive a lens cone 27 to a focus position. The control part 24 displays image data processed by the signal/image processing part 23 on an EVF 28 or an LCD 29, stores the image data in a memory card 31 via a card I/F 30, or transmits the image data to the outside via a communication I/F 32. The control part 24 also controls an electronic-flash circuit 33 to light on an electronic-flash 34, to record sound by a microphone 35, and to reproduce the sound by a speaker 36.

The control part 24 will be further described. The control part 24 has therein an image-capturing control part 37, an evaluation part 38 and a notification part 39. When the mode setting dial 6 in the operation part 25 is set to the group picture mode, the image-capturing control part 37 makes the CCD 21 to perform pre-picture capturing in accordance with the operation and displays a captured picture on the LCD 29 or the like as the display part. By continuously performing pre-picture capturing, a live view can be also displayed on the LCD 29 or the like.

The evaluation part 38 carries out a predetermined analysis on a pre-picture captured by the pre-picture capturing, and determines the presence/absence of unsatisfactory points peculiar to a group picture. Examples of the unsatisfactory points peculiar to a group picture include closing eyes, looking asides, and partial or entire obstruction of a face, and the like. In order to carry out a predetermined analysis, the evaluation part 38 has therein, for example, a contour extraction part 40, a human detection part 41, a face extraction part 42, and a determination part 43.

The contour extraction part 40 extracts contours from the pre-picture, and the human detection part 41 specifies and detects human portions of a plurality of subjects to be photographed from the pre-picture on the basis of geometric characteristics of the contours extracted by the contour extraction part 40. Further, the face extraction part 42 extracts face portions from the human portions specified by the human detection part 41. The determination part 43 determines whether unsatisfactory points peculiar to a group picture exist in the face portions extracted by the face extraction part 42 or not.

For example, in the case of determining whether or not obstruction of a face exists in the pre-picture, the determination part 43 detects a contour from the extracted face portion and, if the contour is an almost circular shape, determines that obstruction of a face does not exist. If the contour is not an almost circular shape, the determination part 43 determines that obstruction of a face exists. As anther determining method, the determination part 43 detects a skin color portion from the extracted face portion and determines that obstruction of a face exists when the area of the skin color portion is much smaller than that of a skin color portion detected from a face portion of another person. As further another determining method, the determination part 43 determines whether or not obstruction of a face exists by detecting whether or not an extracted face portion has all of parts such as eyes, nose and mouth. As further another method of determining obstruction of a face, face portions of humans are specified by a combination of the extraction of a contour and detection of a skin color portion, the position of the center of gravity of each face portion is calculated, and overlap of faces is estimated on the basis of the interval between the center-of-gravity positions.

In the case of determining whether or not closing eyes, looking aside, movement of a face, or the like exists in a pre-picture, the determination part 43 can determine it by detecting whether or not an extracted face portion has all of the parts such as eyes, nose and mouth. The detection of a human, extraction of face portions, and the like are specifically described in known literatures (for example, Japanese Patent Application Laid-Open No. 2000-99691).

If the number of subjects to be photographed in a group picture is input in advance, the evaluation part 38 can compare the number with the number of extracted face portions. By the comparison, the evaluation part 38 can also determine that the face of a subject to be photographed is completely obstructed and that all of subjects to be photographed are not present. By using the function, the apparatus can be regarded as an image capturing apparatus 1 with the function of checking whether or not all of subjects to be photographed are present.

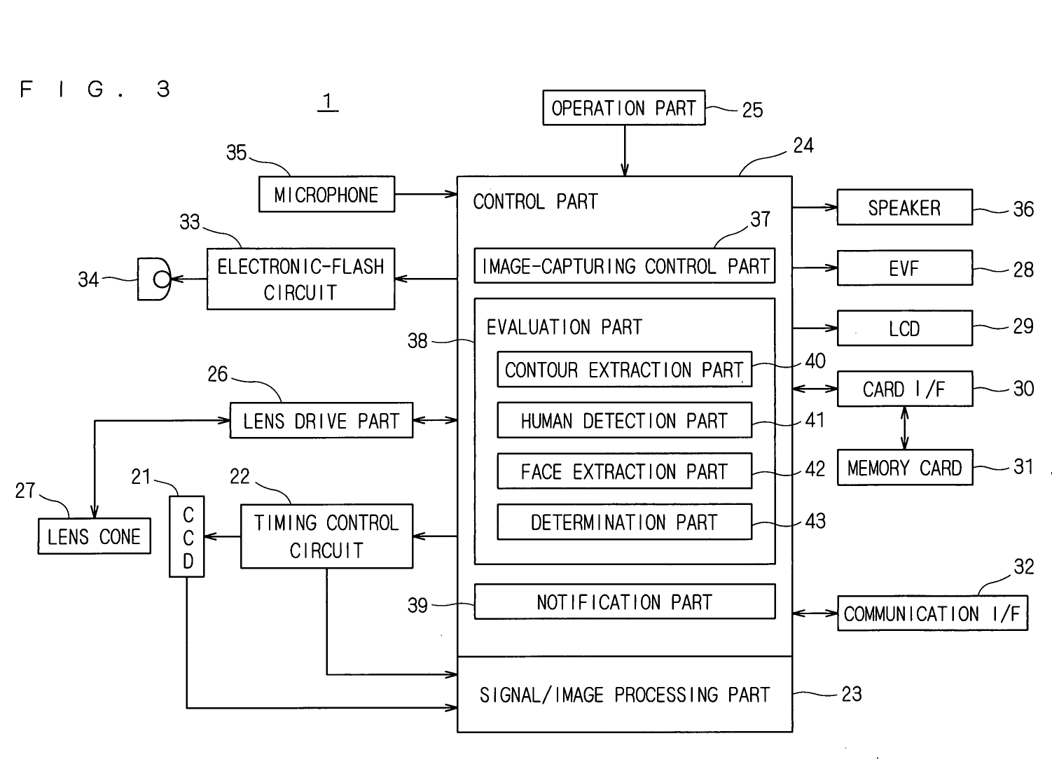

When the evaluation part 38 determines that an unsatisfactory point peculiar to a group picture exists in a pre-picture, concretely, at least one of the face portions of a plurality of subjects to be photographed is partially obstructed, the notification part 39 notifies the user of the unsatisfactory point. As an example of the notifying method, the notification part 39 displays an indication of the existence of an unsatisfactory point and the pre-picture so as to be superimposed on the LCD 29 or the like as a display. Concretely, when a pre-picture as shown in FIG. 4 is obtained in pre-picture capturing of a group picture, the evaluation part 38 determines the existence of an unsatisfactory point that the face of a human 45 is obstructed. As shown in FIG. 5, the notification part 39 displays on the LCD 29 the portion where the face of the human 45 overlaps behind another human so as to be emphasized. In FIG. 5, by flashing a circular mark 46 of a broken line, an unsatisfactory point is emphasized.

On the basis of the flowchart of FIG. 6, the operations of the image capturing apparatus 1 according to this preferred embodiment will be described. First, in step SP 1, the power switch of the image capturing apparatus 1 is turned on to start the image capturing apparatus 1. In step SP2, the mode setting dial 6 is set to the group picture mode. In step SP3, pre-picture capturing is successively performed by the CCD 21.

In step SP4, the captured pre-picture is displayed as a live view on the LCD 29 or the like. In step SP5, the evaluation part 38 detects humans from the pre-picture. The detection of humans performed in step SP5 includes detection of a contour from the pre-picture by the contour extraction part 40, detection of a human portion from the pre-picture on the basis of the contour by the human detection part 41 and, further, extraction of a face portion from the human portion by the face extraction part 42.

In step SP6, the determination part 43 determines whether or not an unsatisfactory point such that an extracted face portion is partially obstructed by another human exists. When the existence of the unsatisfactory point is determined in step SP6, the unsatisfactory portion is displayed so as to be emphasized in step SP7. In the case where the user recognizes the unsatisfactory point on the LCD 29 or the like, the user changes the composition (such as the standing position of a human) in step SP9 without half-pressing the release button 5 in step SP8. After the composition is changed, the processes in step SP3 and subsequent steps are repeated.

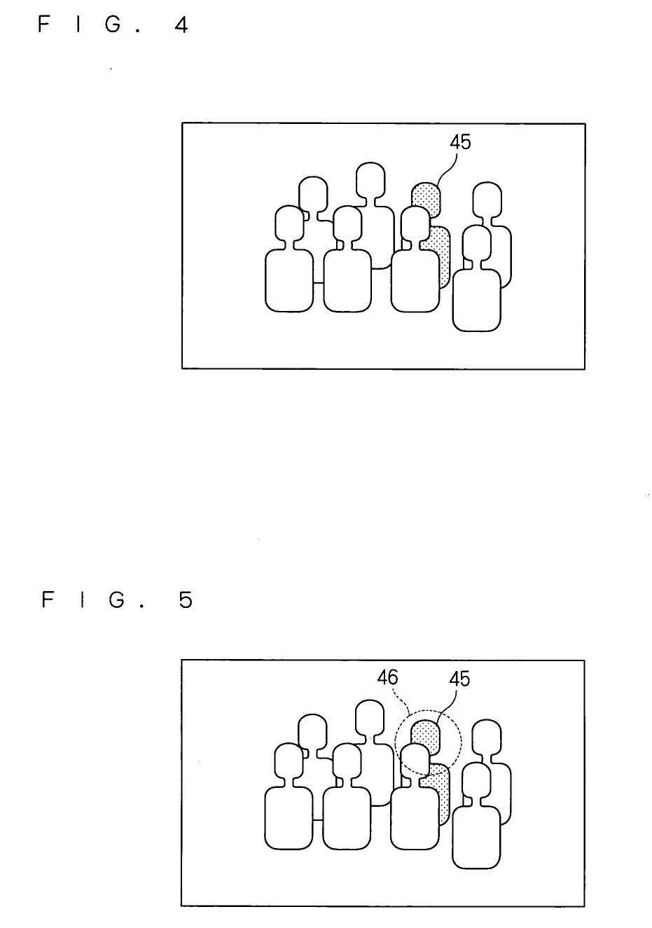

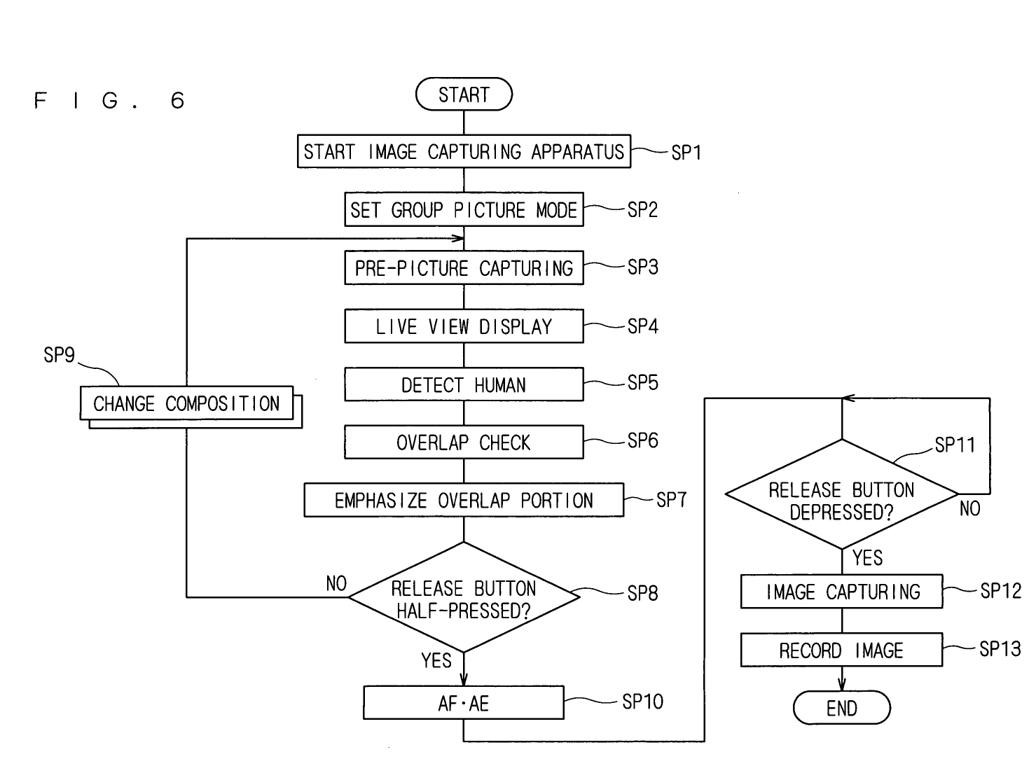

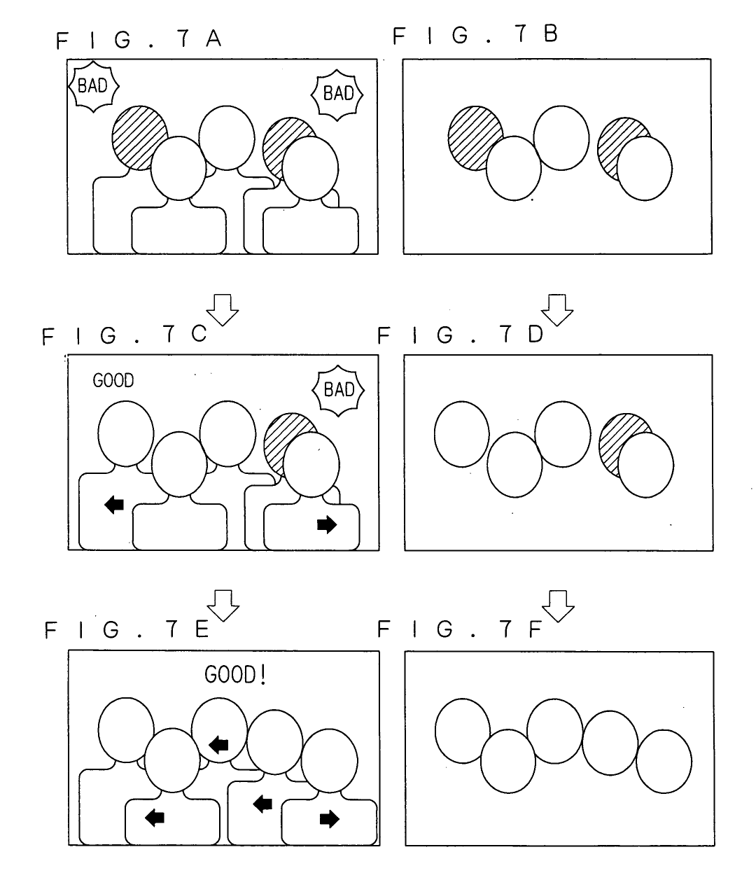

The processes from step SP3 to step SP9 will be concretely described on the basis of the displays of FIGS. 7A to 7F. First, in step SP3, pre-picture capturing is performed to obtain a pre-picture of a group picture as shown in FIG. 7A. In step SP5, face portions are extracted as shown in FIG. 7B from the pre-picture. In step SP6, the presence/absence of an unsatisfactory point of partial obstruction of a face among the extracted face portions. In FIG. 7B, the unsatisfactory point exists in the hatched faces.

In step SP7, the faces of humans in which an unsatisfactory point exists are emphasized by the hatching shown in FIG. 7A. In FIG. 7A, in order to make the user recognize the unsatisfactory point more clearly, “bad” is indicated in the vicinity of the unsatisfactory point.

The user who recognizes the unsatisfactory point updates the pre-picture capturing by changing the composition in step SP9. In FIG. 7C, the composition is changed by moving humans positioned at the right and left ends in the directions of the arrows. After the composition change, the user performs the processes from step SP3 to SP7 again. FIG. 7D shows the face portions extracted from the pre-picture after the composition change, and the face portions in which the unsatisfactory point exists are hatched. In step SP7, the faces of humans in which the unsatisfactory point exists are emphasized by being hatched as shown in FIG. 7C. In addition, “good” is indicated in the vicinity of the place where the unsatisfactory point is eliminated and “bad” is indicated in the vicinity of the unsatisfactory point.

The user who recognizes the unsatisfactory point changes the composition again in step SP9. In FIG. 7E, the composition is changed again by moving the human positioned at the right end and three humans in the center in the arrow directions. After the re-change of the composition, the processes from step SP3 to SP7 are performed again. FIG. 7F shows the face portions extracted from the pre-picture after changing the re-composition, having no unsatisfactory point in the face portions. In step SP7, as shown by indication of “good” in FIG. 7E, elimination of the unsatisfactory point is indicated.

The pre-picture capturing is updated as described above, all of unsatisfactory points peculiar to a group picture are eliminated in the pre-picture and, after that, the user half-presses the release button 5 in step SP8. Consequently, AF and AE processes are performed in step SP10. Next, in step SP11, the apparatus waits for depression of the release button 5 by the user. When the user depresses the release button 5, image capturing is performed in step SP12. Subsequently, a picture captured by the image capturing is recorded on the memory card 31 in step SP13 and, after that, the routine is finished.

In the flowchart shown in FIG. 6, a pre-picture in which only an unsatisfactory point of partial obstruction of a face exists has been described. In the present invention, however, if there is only an unsatisfactory point peculiar to a group picture, processes can be performed in a manner similar to the flowchart of FIG. 6. A pre-picture in which partial obstruction of a face and looking aside as unsatisfactory points peculiar to a group picture exist will be described below.

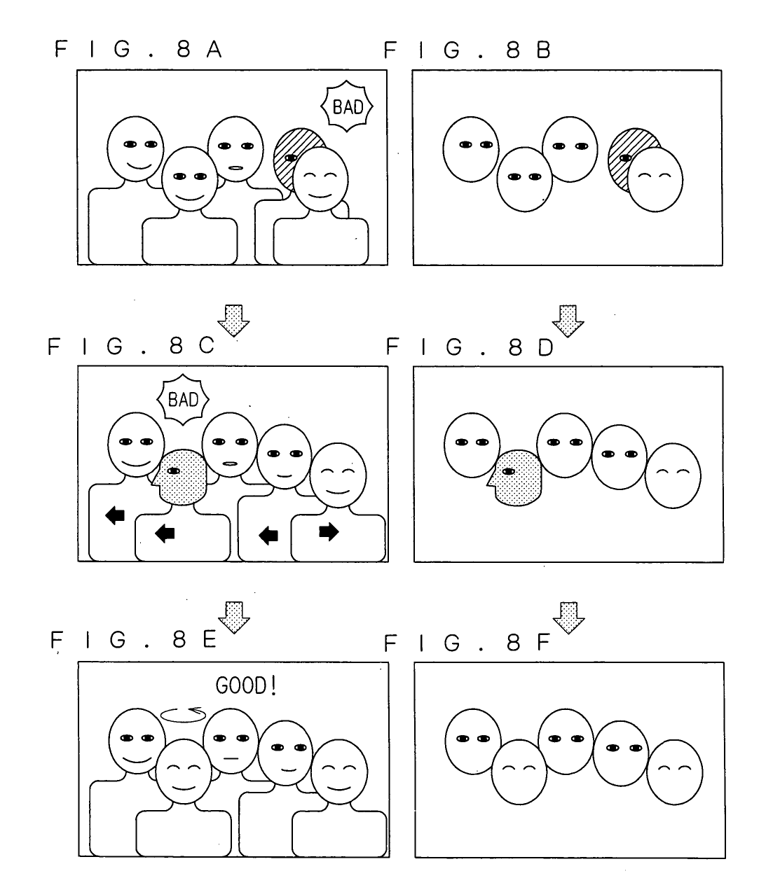

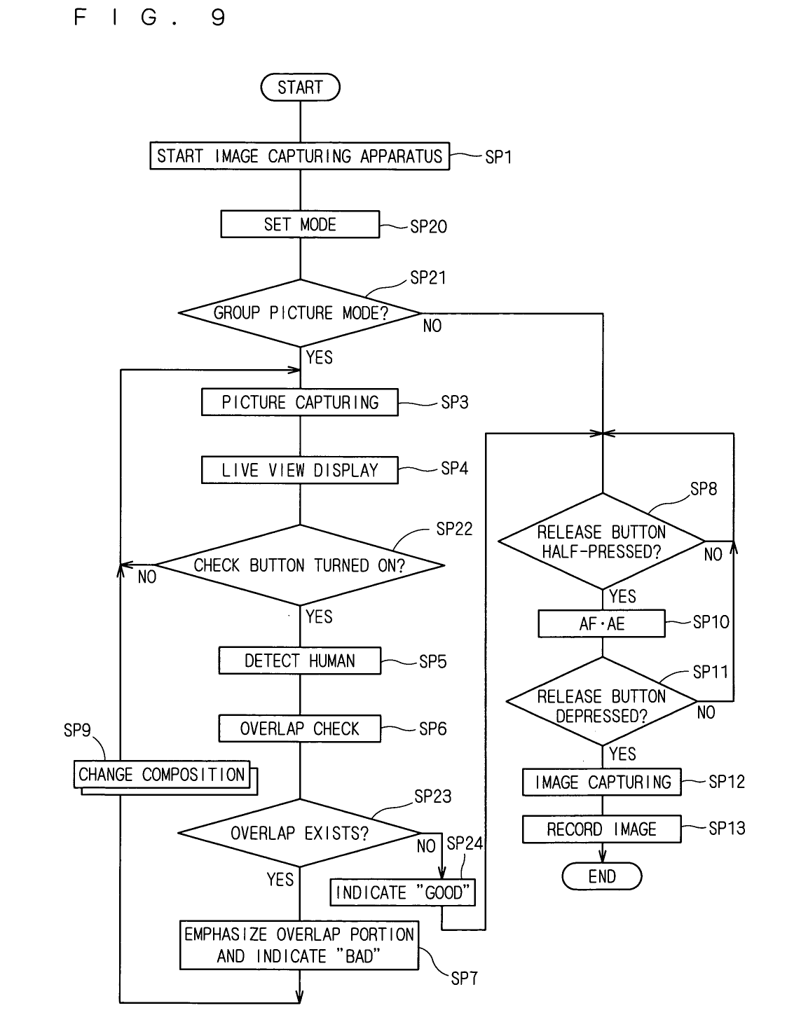

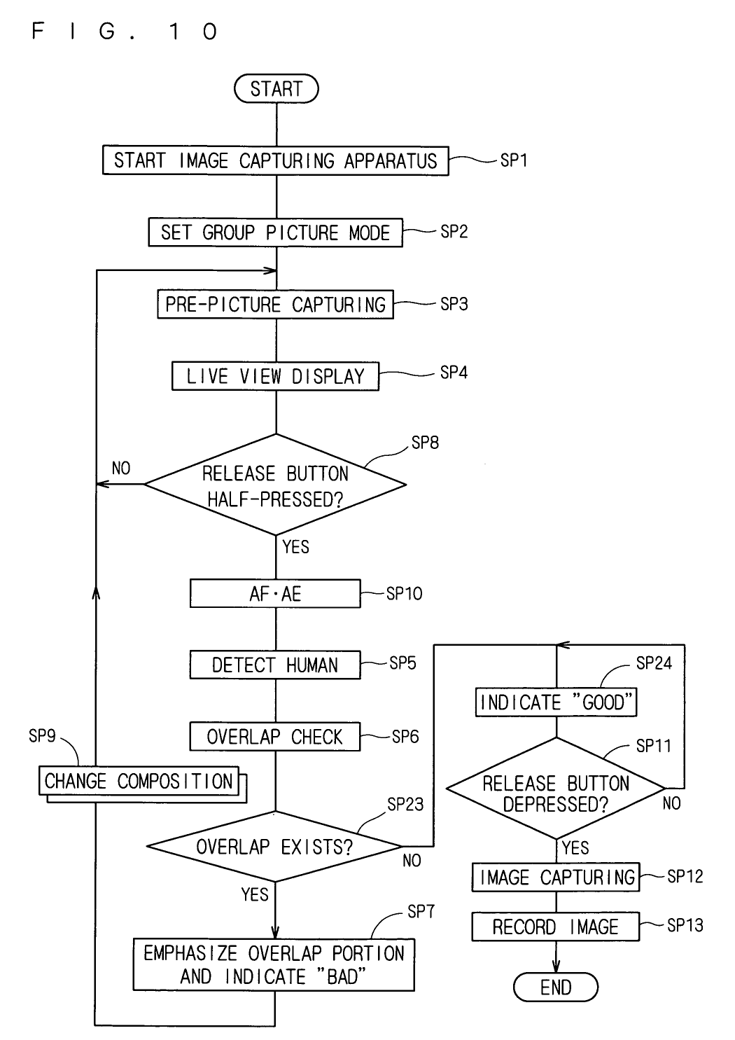

First, as shown in FIG. 8A, in the case of a pre-picture having an unsatisfactory point that the face of one of humans is partially obstructed, the unsatisfactory point is determined in step SP6. The determined unsatisfactory point is emphasized by hatching and indication of “bad” as shown in FIG. 8A in step SP7. FIG. 8B illustrates the face portions (including eyes) extracted in step SP5 from the pre-picture shown in FIG. 8A.

When user recognizes the unsatisfactory point shown in FIG. 8A, the user changes the composition in step SP9. The composition of FIG. 8A is changed by moving subjects in the directions of arrows shown in FIG. 8C. When the overlap check in step SP6 is made on the picture subjected to composition change, the unsatisfactory point is not detected. However, when a looking-aside check (not shown in the flowchart of FIG. 6) is performed, an unsatisfactory point that the second person from the left looks aside is found. The looking-aside check is performed by the determination part 43 by determining whether or not the face portion extracted in step SP5 has all of the eyes, nose, mouth and the like. In the example shown in FIG. 8D, whether the face portion has two eyes or not is checked, thereby determining whether or not the person looks aside. FIG. 8D shows the face portions (including the eyes) extracted in step SP5 from the pre-picture shown in FIG. 8C.

In step SP7, the face of the person looking aside is hatched and indicated with “bad” so as to be emphasized as shown in FIG. 8C. The user recognizes the display of FIG. 8C and changes the composition again in step SP9. The composition re-change of FIG. 8C is performed by making the subject looking aside look at the image capturing apparatus 1 as shown in FIG. 8E. When the overlap check and the looking-aside check are made on the pre-picture after the composition re-change, an unsatisfactory point is not detected and “good” is indicated as shown in FIG. 8E. FIG. 8F shows a face portion (including eyes) extracted in step SP5 from the pre-picture shown in FIG. 8E.

As described above, the image capturing apparatus 1 according to the embodiment carries out a predetermined analysis on a pre-picture captured by the pre-picture capturing to determine the presence/absence of an unsatisfactory point peculiar to a group picture. When it is determined that a pre-picture has an unsatisfactory point, the image capturing apparatus 1 notifies the user of the unsatisfactory point. Consequently, an unsatisfactory point peculiar to a group picture can be avoided and a group picture without a failure can be captured. By using the image capturing apparatus 1 according to this preferred embodiment, the psychological burden on the user taking a group picture can be lessened.

### Second Preferred Embodiment

The image capturing apparatus 1 according to a second preferred embodiment performs operations different from those of the flowchart of FIG. 6. FIG. 9 is a flowchart showing operations of the image capturing apparatus 1 according to the second preferred embodiment. In the flowchart shown in FIG. 9, the steps in which the same processes as those in the flowchart of FIG. 6 are performed are designated with the same reference numerals.

First, in step SP1, the power switch of the image capturing apparatus 1 is turned on to start the image capturing apparatus 1. In step SP20, the user sets a desired mode with the mode setting dial 6. In step SP21, it is determined whether or not a group picture mode is set. In the case where the group picture mode is set, the program advances to step SP3. In the case where a mode other than the group picture mode is set, the program advances to step SP8.

In step SP3, pre-picture capturing is successively performed by the CCD 21. In step SP4, the captured pre-picture is displayed as a live view on the LCD 29 or the like. In this preferred embodiment, the user can arbitrarily select a pre-picture to be subjected to a check of the presence/absence of an unsatisfactory point peculiar to a group picture from pre-pictures displayed as live views. Specifically, whether or not the user presses a check button in the operation part 25 is determined in step SP22. When it is determined that the check button is depressed, the program advances to step SP5 and checks the presence/absence of an unsatisfactory point peculiar to a group picture in the pre-picture for which the check button is depressed. On the other hand, when the check button is not depressed, steps SP3 and SP4 are repeated.

In step SP5, the evaluation part 38 detects humans from the pre-picture selected by the user. In step SP6, whether or not an unsatisfactory point such that an extracted face portion is partially obstructed by another human exists is determined. In step SP23, when the existence of the unsatisfactory point is determined in step SP6, the program advances to step SP7. When it is determined that the unsatisfactory points do not exist, the program advances to step SP24.

In the second preferred embodiment, different from the first preferred embodiment, when an unsatisfactory point exists in a pre-picture, the user is inhibited from performing image capturing. In other words, the composition has to be changed in step SP9 until it is determined in step SP6 that an unsatisfactory point does not exist.

When it is determined in step SP6 that an unsatisfactory point does not exist, “good” is indicated on the LCD 29 or the like in step SP24, and the user is urged to perform image capturing. When “good” is indicated in step SP24, in step SP8, the image capturing apparatus 1 waits for half-press of the release button 5. In step SP10, the AF and AE processes are performed. In step SP11, the image capturing apparatus 1 waits for depression of the release button 5 by the user. When the user depresses the release button 5, the image capturing is performed in step SP12. Subsequently, in step SP 13, a picture captured by the image capturing is recorded on the memory card 31 and, after that, the routine is finished.

As described above, the image capturing apparatus 1 according to the second preferred embodiment can inhibit the image capturing until an unsatisfactory point is eliminated. Therefore, the user can be prevented from depressing the release button 5 by mistake to capture a group picture having an unsatisfactory point.

### Third Preferred Embodiment

An image capturing apparatus 1 according to a third preferred embodiment performs operations different from those of the flowcharts of FIGS. 6 and 9. FIG. 10 is a flowchart showing operations of the image capturing apparatus 1 according to the third preferred embodiment. In the flowchart shown in FIG. 10, the steps in which the same processes as those in the flowchart of FIG. 6 are performed are designated with the same reference numerals.

First, in step SP1, the power switch of the image capturing apparatus 1 is turned on to start the image capturing apparatus 1. In step SP2, the user sets the mode setting dial 6 to a group picture mode. In step SP3, pre-picture capturing is successively performed by the CCD 21. In step SP4, the captured pre-picture is displayed as a live view on the LCD 29 or the like. In the third preferred embodiment as well, in a manner similar to the second preferred embodiment, the user can arbitrarily select a pre-picture to be subjected to a check of the presence/absence of an unsatisfactory point peculiar to a group picture from pre-pictures displayed as live views.

The image capturing apparatus 1 according to the third preferred embodiment, however, is different from that of the second preferred embodiment with respect to the point that a pre-picture is selected when the release button 5 is half-pressed without using the check button of the operation part 25. Specifically, whether or not the user half-presses the release button 5 is determined in step SP8. In the case where the user half-presses the release button 5, the program advances to steps SP10 and SP5 and determines the presence/absence of unsatisfactory points peculiar to a group picture in the pre-picture selected when the release button 5 is half-pressed. On the other hand, when the release button 5 is not half-pressed, the program repeats steps SP3 and SP4.

In step SP10, the AF and AE processes are performed. In step SP5, the evaluation part 38 performs human detection on the pre-picture selected by the user. In step SP6, whether or not an unsatisfactory point that the extracted face portion is partially obstructed by another human exists is determined. In step SP23, when the presence of the unsatisfactory point is determined in step SP6, the program advances to step SP7. When the absence of the unsatisfactory point is determined, the program advances to step SP24.

Also in the third preferred embodiment, different from the first preferred embodiment, the user is prohibited from performing image capturing. That is, the user has to change the composition in step SP9 until it is determined in step SP6 that the unsatisfactory point does not exist.

When the absence of the unsatisfactory point is determined in step SP6, in step SP24, “good” is indicated on the LCD 29 or the like and the user is urged to perform image capturing. When “good” is indicated in step SP24, in step SP11, the image capturing apparatus 1 waits for depression of the release button 5 by the user. When the user depresses the release button 5, the image capturing is performed in step SP12. Subsequently, in step SP13, a picture captured by the image capturing is recorded on the memory card 31 and, after that, the routine is finished.

As described above, in the image capturing apparatus 1 according to this preferred embodiment, by half-pressing the release button 5, a pre-picture to be subjected to a check to see the presence/absence of unsatisfactory points peculiar to a group picture can be selected. Thus, the time lag between pre-picture capturing and the image capturing can be shortened and the image capturing can be performed smoothly.

The image capturing apparatus 1 according to any one of the first to third preferred embodiments may be further provided with a switch for automatically switching the setting mode to the group picture mode when only contours are extracted from a pre-picture captured by pre-picture capturing and humans are detected from the contours, thereby recognizing the existence of a plurality of humans in the pre-picture. By providing the switch for the image capturing apparatus 1, the user can be prevented from forgetting to set to the group picture mode. The switch can be provided in, for example, the control part 24.

While the invention has been shown and described in detail, the foregoing description is in all aspects illustrative and not restrictive. It is therefore understood that numerous modifications and variations can be devised without departing from the scope of the invention.

What is claimed is:

1. An image capturing apparatus comprising:
an image capturing part;
an operation part for operating said image capturing part;
a display part for displaying a picture captured by said image capturing part;
an image-capturing control part for performing a control so that said image capturing part performs pre-picture capturing in accordance with an operation of said operation part;
an evaluation part for carrying out a predetermined analysis on a pre-picture captured by said pre-picture capturing and determining the presence/absence of an unsatisfactory point peculiar to a group picture; and
a notification part, when said evaluation part determines that said pre-picture has said unsatisfactory point, for notifying the user of said unsatisfactory point.

2. The image capturing apparatus according to claim 1, wherein
said notification part displays indication of the presence of said unsatisfactory point and said pre-picture so as to be superimposed.

3. The image capturing apparatus according to claim 1, wherein
said evaluation part includes:
a contour extraction part for extracting a contour from said pre-picture;
a human detection part for detecting a human from said contour extracted by said contour extraction part;
a face extraction part for extracting a face portion of said human detected by said human detection part; and
a determination part for determining the presence/absence of overlap of the face portion with another human on the basis of a picture state of said face portion, wherein
the presence/absence of said overlap is determined as the presence/absence of said unsatisfactory point.

4. The image capturing apparatus according to claim 3, wherein
said notification part displays an overlap portion of said face portion with another human determined by said determination part so as to be emphasized on said display part.

5. The image capturing apparatus according to claim 1, wherein
when said unsatisfactory point is eliminated by updating of pre-picture capturing, said notification part displays an indication of urging the user to perform image capturing on said display part.

6. The image capturing apparatus according to claim 1, wherein
said image-capturing control part inhibits the image capturing until said unsatisfactory point is eliminated by updating of the pre-picture capturing.

7. The image capturing apparatus according to claim 1, wherein
said operation part has a release button, and
said image-capturing control part controls so that said image capturing part performs pre-picture capturing in response to a half-press operation on said release button, and inhibits the image capturing to be performed in response to an operation of depressing said release button until said unsatisfactory point in said pre-picture is eliminated by updating of the pre-picture capturing.

8. An image capturing apparatus capable of selecting, as a setting mode, a group picture mode of capturing an image of a plurality of subjects gathered, comprising, as a group of parts activated in said group picture mode:
a live view part for repeatedly performing image capturing in an image capturing part;
an evaluation part for carrying out a predetermined analysis on a picture captured by said live view part, and determining the presence/absence of an unsatisfactory point peculiar to a group picture; and
a notification part, when said evaluation part determines that said picture has said unsatisfactory point, for notifying the user of said unsatisfactory point by superimposing indication of the presence of said unsatisfactory point on said picture.

9. The image capturing apparatus according to claim 8, further comprising:
as one of said group of parts activated in said group picture mode, a part for inhibiting image capturing until said unsatisfactory part of said picture is eliminated by updating of the image capturing.

10. The image capturing apparatus according to claim 8, further comprising:
a switch part for switching said setting mode to said group picture mode when the existence of a plurality of humans in a pre-picture is recognized by extracting contours from said pre-picture obtained by pre-picture capturing and detecting humans from said contours.
